(19) United States
(12) Patent Application Publication
(10) Pub. No.: US 2026/0185642 A1
(43) Pub. Date: Jul. 2, 2026

(54) SYSTEMS FOR TRANSFERRING FLUID ACROSS A BOUNDARY AND PROCESSES FOR USING SAME

(71) Applicant: SOFEC, INC., HOUSTON, TX (US)

(72) Inventors: MILES HOBDY, Richmond, TX (US); DOUG MCSHAN, Houston, TX (US)

(73) Assignee: SOFEC, INC., HOUSTON, TX (US)

(21) Appl. No.: 19/393,721

(22) Filed: Nov. 19, 2025

Related U.S. Application Data
(60) Provisional application No. 63/722,079, filed on Nov. 19, 2024.

(51) Int. Cl. F16L 39/06; E21B 43/01

(52) U.S. Cl. CPC F16L 39/06; E21B 43/01

(57) ABSTRACT

Systems for transferring fluid across a boundary between a first body rotatively coupled to a second body that can include first, second, third, fourth, and fifth fluid conduits and first and second fluid swivels. The first conduit can be disposed on the first body and in communication with the second conduit. The third conduit can be disposed on the second body and in communication with the fourth conduit. The first and second swivels can each include a fixed part rotatively coupled to a rotating part. The rotating part of the first swivel can be in communication with the first conduit. The fixed part of the second swivel can be in communication with the third conduit. The fifth conduit can maintain communication between either one of: (i) the fixed part of the first swivel and the fourth conduit and (ii) the second conduit and the rotating part of the second swivel.

### CROSS-REFERENCE TO RELATED APPLICATION

This application claims priority to U.S. Provisional Patent Application No. 63/722,079, filed on Nov. 19, 2024, which is incorporated by reference herein.

### FIELD

Embodiments described generally relate to systems for transferring fluid across a boundary and processes for using same. More particularly, such embodiments relate to systems for transferring fluid across a boundary between a first body rotatively coupled to a second body and processes for using same.

### BACKGROUND

In the offshore oil and gas industry, it is common to configure a floating vessel to rotate about a rotationally fixed or geostationary structure. This can be accomplished, for example with a turret mooring system. The turret mooring system can include a rotating part connected to the floating vessel and a fixed part connected to the seabed that can be connected to one another via a bearing system. Such turret mooring systems typically include a fluid conveyance system to provide fluid communication between the vessel and subsea well(s) or fluid conduit(s) located on the seabed. Such fluid conveyance system spans or crosses from the fixed part of the turret to the rotating part of the turret and maintains fluid communication between the rotating part of the turret and the fixed part of the turret as the vessel and rotating part of the turret rotate about the fixed part of the turret.

Fluid swivels occasionally need to be removed or at least temporarily taken out of service for maintenance or repair. For example, seals inside the fluid swivel can become damaged and require replacement. The downtime associated with the repair or replacement of a damaged swivel can be undesirably long leading to an undesired downtime in the transfer of fluid between the vessel and the subsea well(s) or fluid conduit(s) located on the seabed.

There is a need, therefore, for improved systems for transferring fluid across a boundary between a first body rotatively coupled to a second body and processes for using same.

### SUMMARY

Systems for transferring fluid across a boundary between a first body rotatively coupled to a second body and processes for using same are provided. In some embodiments, the system can include a first fluid conduit, a second fluid conduit, a third fluid conduit, a fourth fluid conduit, a fifth fluid conduit, a first fluid swivel, and a second fluid swivel. The first fluid conduit can be configured to be disposed on the first body. The second fluid conduit can be in fluid communication with the first fluid conduit. The third fluid conduit can be configured to be disposed on the second body. The fourth fluid conduit can be in fluid communication with the third fluid conduit. The first fluid swivel can include a fixed part rotatively coupled to a rotating part. The rotating part of the first fluid swivel can be in fluid communication with the first fluid conduit. The second fluid swivel can include a fixed part rotatively coupled to a rotating part. The fixed part of the second fluid swivel can be in fluid communication with the third fluid conduit. The fifth fluid conduit can be configured to maintain fluid communication between (i) the fixed part of the first fluid swivel and the fourth fluid conduit or (ii) the second fluid conduit and the rotating part of the second fluid swivel.

In other embodiments, the system for transferring a fluid between a first body rotatively coupled to a second body can include a first fluid conduit, a second fluid conduit, a third fluid conduit, a fourth fluid conduit, a fifth fluid conduit, a first fluid swivel, and a second fluid swivel. The first fluid conduit can be disposed on the first body and can include a first valve. The second fluid conduit can be in fluid communication with the first fluid conduit and can include a second valve. The third fluid conduit can be disposed on the second body and can include a third valve. The fourth fluid conduit can be in fluid communication with the third fluid conduit and can include a fourth valve. The first fluid swivel can include a fixed part rotatively coupled to a rotating part. The rotating part of the first fluid swivel can be in fluid communication with the first fluid conduit. The second fluid swivel can include a fixed part rotatively coupled to a rotating part. The fixed part of the second fluid swivel can be in fluid communication with third fluid conduit. The fifth fluid conduit can be configured to fluidly connect to either one of: (i) the fixed part of the first fluid swivel and the fourth fluid conduit or (ii) the rotating part of the second fluid swivel and the second fluid conduit. The first fluid conduit, the first fluid swivel, the fifth fluid conduit, and the fourth fluid conduit can define a first fluid path when the fifth fluid conduit is fluidly connected to the fixed part of the first fluid swivel and the fourth fluid conduit. The second fluid conduit, the fifth fluid conduit, the second fluid swivel, and the third fluid conduit can define a second fluid path when the fifth fluid conduit is fluidly connected to the rotating part of the second fluid swivel and the second fluid conduit.

In some embodiments a process for redirecting a fluid flow from a first fluid path to a second fluid path in a system configured to transfer a fluid between a first body rotatively coupled to a second body can include closing a first valve and a fourth valve of the system. The system can include a first fluid conduit, a second fluid conduit, a third fluid conduit, a fourth fluid conduit, a fifth fluid conduit, a first fluid swivel, and a second fluid swivel. The first fluid conduit can be disposed on the first body and can include the first valve. The second fluid conduit can be in fluid communication with the first fluid conduit and can include a second valve. The third fluid conduit can be disposed on the second body and can include a third valve. The fourth fluid conduit can be in fluid communication with the third fluid conduit and can include the fourth valve. The first fluid swivel can include a fixed part rotatively coupled to a rotating part. The rotating part of the first fluid swivel can be in fluid communication with the first fluid conduit. The second fluid swivel can include a fixed part rotatively coupled to a rotating part. The fixed part of the second fluid swivel can be in fluid communication with third fluid conduit. The fifth fluid conduit can be fluidly connected to the fixed part of the first fluid swivel and the fourth fluid conduit. The first fluid path can be defined by the first fluid conduit, the first valve, the first fluid swivel, the fifth fluid conduit, the fourth fluid conduit, and the fourth valve. The process can also include disconnecting the fifth fluid conduit from the fixed part of the first fluid swivel and the fourth fluid conduit. The process can also include connecting the fifth fluid conduit or a sixth fluid conduit to the second fluid conduit and the rotating part of the second fluid swivel. The process can also include opening the second valve and the third valve to establish fluid communication between the second fluid conduit and the third fluid conduit. The second fluid path can be defined by the second fluid conduit, the second valve, the fifth fluid conduit or the sixth fluid conduit, the second fluid swivel, the third valve, and the third fluid conduit.

### BRIEF DESCRIPTION OF THE DRAWINGS

The various aspects and advantages of the preferred embodiment of the present invention will become apparent to those skilled in the art upon an understanding of the following detailed description of the invention, read in light of the accompanying drawings which are made a part of this specification.

FIG. 1 depicts an illustrative system for transferring a fluid between a first body rotatively coupled to a second body in a first configuration, according to one or more embodiments described.

FIG. 2 depicts a system similar to the system shown in FIG. 1 that includes an additional fluid conduit, according to one or more embodiments described.

FIG. 3 depicts another illustrative system for transferring a fluid between a first body rotatively coupled to a second body in a first configuration, according to one or more embodiments described.

### DETAILED DESCRIPTION

A detailed description will now be provided. Each of the appended claims defines a separate invention, which for infringement purposes is recognized as including equivalents to the various elements or limitations specified in the claims. Depending on the context, all references to the “invention”, in some cases, refer to certain specific or preferred embodiments only. In other cases, references to the “invention” refer to subject matter recited in one or more, but not necessarily all, of the claims. It is to be understood that the following disclosure describes several exemplary embodiments for implementing different features, structures, or functions of the invention. Exemplary embodiments of components, arrangements, and configurations are described below to simplify the present disclosure; however, these exemplary embodiments are provided merely as examples and are not intended to limit the scope of the invention. Additionally, the present disclosure may repeat reference numerals and/or letters in the various exemplary embodiments and across the figures provided herein. This repetition is for the purpose of simplicity and clarity and does not in itself dictate a relationship between the various exemplary embodiments and/or configurations discussed in the Figures. Moreover, the formation of a first feature over or on a second feature in the description that follows includes embodiments in which the first and second features are formed in direct contact and also includes embodiments in which additional features are formed interposing the first and second features, such that the first and second features are not in direct contact. The exemplary embodiments presented below may be combined in any combination of ways, i.e., any element from one exemplary embodiment may be used in any other exemplary embodiment, without departing from the scope of the disclosure. The figures are not necessarily drawn to scale and certain features and certain views of the figures can be shown exaggerated in scale or in schematic for clarity and/or conciseness.

Additionally, certain terms are used throughout the following description and claims to refer to particular components. As one skilled in the art will appreciate, various entities may refer to the same component by different names, and as such, the naming convention for the elements described herein is not intended to limit the scope of the invention, unless otherwise specifically defined herein. Also, the naming convention used herein is not intended to distinguish between components that differ in name but not function. Furthermore, in the following discussion and in the claims, the terms “including” and “comprising” are used in an open-ended fashion, and thus should be interpreted to mean “including, but not limited to.”

All numerical values in this disclosure are exact or approximate values (“about”) unless otherwise specifically stated. Accordingly, various embodiments of the disclosure may deviate from the numbers, values, and ranges disclosed herein without departing from the intended scope.

Further, the term “or” is intended to encompass both exclusive and inclusive cases, i.e., “A or B” is intended to be synonymous with “at least one of A and B,” unless otherwise expressly specified herein. The indefinite articles “a” and “an” refer to both singular forms (i.e., “one”) and plural referents (i.e., one or more) unless the context clearly dictates otherwise. The terms “up” and “down”; “upward” and “downward”; “upper” and “lower”; “upwardly” and “downwardly”; “above” and “below”; and other like terms used herein refer to relative positions to one another and are not intended to denote a particular spatial orientation since the apparatus and methods of using the same may be equally effective at various angles or orientations.

It should also be understood that the phrases “disposed therein”, “disposed within”, “disposed on” and other similar phrases, when describing a component, e.g., a second arm, describe the component as being partially disposed therein/within/on or completely disposed therein/within/on. For example, if the component is a second arm disposed within a bore or an aperture defined by a first arm, the second arm can be disposed partially within the aperture or completely within the aperture. In another example, if the component is a stopper assembly disposed on a second end of a first arm, the phrase “the stopper assembly can be disposed on the second end of the arm ” means the stopper assembly can be partially disposed on the second end of the arm or completely on the second end of the arm.

The terms “rotate”, “rotation”, “rotatable”, and “rotating” are used interchangeably and refer to the partial or complete turning of a body around an axis or center point.

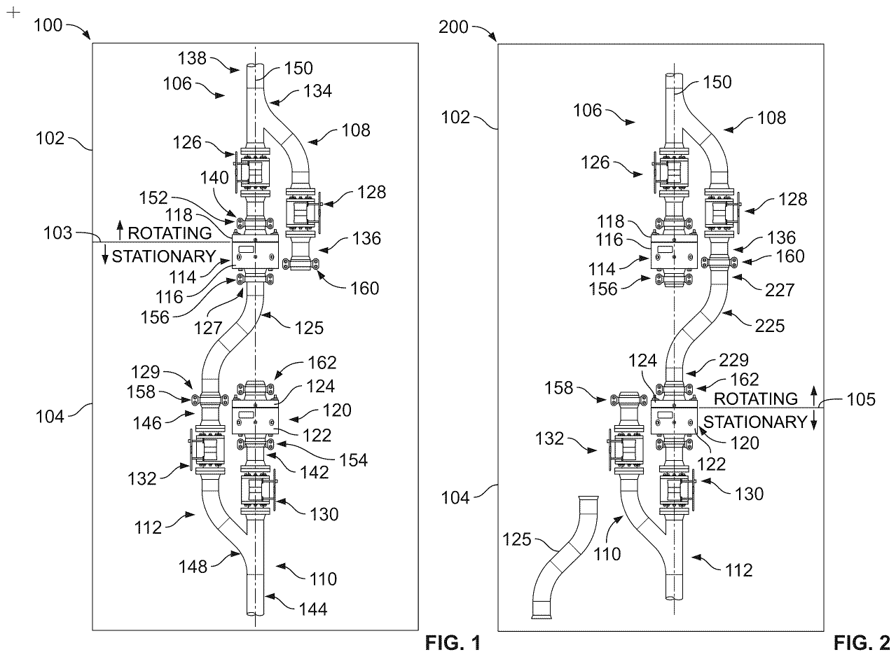

FIG. 1 depicts an illustrative system 100 for transferring a fluid between a first body 102 rotatively coupled to a second body 104 in a first configuration, according to one or more embodiments. The system 100 can include a first fluid conduit 106, a second fluid conduit 108, a third fluid conduit 110, a fourth fluid conduit 112, a fifth fluid conduit 125, a first fluid swivel 114, and a second fluid swivel 120. Line 103 represents the boundary between the first body 102 configured to rotate relative to the second body 104.

In some embodiments, the first body 102 can be configured as a rotating part of a turret mooring system and the second body 104 can be configured as a rotationally fixed or geostationary part of the turret mooring system. In other embodiments, the first body 102 can be configured as a rotating part of a turret mooring system and the second body 104 can be configured as a substantially rotationally fixed or substantially geostationary part of the turret mooring system. In some embodiments, the first body 102 can be configured as a rotating part of a yoke mooring system and the second body 104 can be configured as a rotationally fixed or geostationary part of the yoke mooring system. In other embodiments, the first body 102 can be configured as a rotating part of a yoke mooring system and the second body 104 can be configured as a substantially rotationally fixed or substantially geostationary part of the yoke mooring system, for example a base structure or jacket structure. In other words, the second body 104 can be configured to be rotationally fixed or geostationary or substantially rotationally fixed or substantially geostationary about a longitudinal axis 150 relative to the earth. For example, in some embodiments, the second body 104 can be moored to a seabed via two or more mooring lines. As used herein, the terms “substantially rotationally fixed” and “substantially geostationary” are used interchangeably and mean that the second body 104 can rotate about the longitudinal axis 150 relative to the earth by about +/−20° or less, about +/−15° or less, about +/−12° or less, about +/−10° or less, about +/−7° or less, about +/−5° or less, about +/−3° or less, or about +/−1° or less.

In some embodiments, the first body 102 can rotate relative to the second body 104 about the longitudinal axis 150. In some embodiments, at least a portion of the first fluid conduit 106 can be longitudinally aligned with the longitudinal axis 150. In some embodiments, at least a portion of the third fluid conduit 110 can be longitudinally aligned with the longitudinal axis 150. In some embodiments, the first fluid swivel 114 and the second fluid swivel 120 can each define a bore therethrough. In some embodiments, the bore or at least a portion thereof defined by the first fluid swivel 114 and the bore or at least a portion thereof defined by the second fluid swivel 120 can be aligned along the longitudinal axis 150. In some embodiments, at least a portion of the first fluid conduit 106 can be longitudinally aligned with the longitudinal axis 150 and at least a portion of the third fluid conduit 110 can be longitudinally aligned with the longitudinal axis 150. As such, in some embodiments, at least a portion of the first fluid conduit 106, the bore defined by the first fluid swivel 114, the bore defined by the second fluid swivel 120, and at least a portion of the third fluid conduit 110 can each be longitudinally aligned with or along the longitudinal axis 150. In some embodiments, at least a portion of a bore defined by the first fluid conduit 106, the bore defined by the first fluid swivel 114, the bore defined by the second fluid swivel 120, and at least a portion of a bore defined by the third fluid conduit 110 can each be longitudinally aligned with or along the longitudinal axis 150.

In some embodiments, the first body 102 can be a part of or can be configured to be disposed on and secured to a floating structure. In some embodiments, the floating structure can be a floating vessel. Illustrative vessels can be any type of floating structure including, but not limited to, ships; tankers; boats; floating platforms; floating, storage, and offloading (FSO) vessels; floating, production, storage, and offloading (FPSO) vessels, floating liquified natural gas (FLNG) vessels; floating, storage, regasification, units (FSRU); and the like.

In some embodiments, the first fluid conduit 106 can be disposed on the first body 102. The second fluid conduit 108 can be in fluid communication with the first fluid conduit 106. For example, in some embodiments, a first end 134 of the second fluid conduit 108 can be in fluid communication with the first fluid conduit 106 at a location between a first end 138 and a second end 140 of the first fluid conduit 106. In some embodiments, the first fluid conduit 106 and the second fluid conduit 108 can be connected to one another in a wye configuration. In some embodiments, the first end 138 of the first fluid conduit 106 can be in fluid communication with a storage tank or a piping system located on the vessel to which the first body 102 can be part of or can be disposed on and secured to. The second end 140 of the first fluid conduit 106 can be in fluid communication with the rotating part 118 of the first fluid swivel 114. In some embodiments, a conduit connector 152 can be used to couple the second end 140 of the first fluid conduit 106 to the rotating part 118 of the first fluid swivel 114.

The third fluid conduit 110 can be disposed on the second body 104. The fourth fluid conduit 112 can be in fluid communication with the third conduit 110. For example, in some embodiments, a second end 148 of the fourth fluid conduit 112 can be in fluid communication with the third fluid conduit 110 at a location between a first end 142 and a second end 144 of the third fluid conduit 110. In some embodiments, the third fluid conduit 110 and the fourth fluid conduit 112 can be connected to one another in a wye configuration. The first end 142 of the third fluid conduit 110 can be in fluid communication with the fixed part 122 of the second fluid swivel 120. In some embodiments, a conduit connector 154 can be used to couple the first end 142 of the third fluid conduit 110 to the fixed part 122 of the second fluid swivel 120. In some embodiments, the second end 144 of the third fluid conduit 110 can be in fluid communication with a fluid conduit disposed on the second body 104, a subsea well, a pipeline, or any other conduit.

In some embodiments, the fifth fluid conduit 125 can be configured to maintain fluid communication between the fixed part 116 of the first fluid swivel 114 and a first end 146 of the fourth fluid conduit 112. In some embodiments, a conduit connector 156 can be used to couple a first end 127 of the fifth fluid conduit 125 to the fixed part 116 of the first fluid swivel 114 and a conduit connector 158 can be used to couple a second end 129 of the fifth fluid conduit 125 to the first end 146 of the fourth fluid conduit 112. In other embodiments, the fifth fluid conduit 125 can be configured to maintain fluid communication between the second fluid conduit 108 and the rotating part 124 of the second fluid swivel 120. In some embodiments, a conduit connector 160 can be used to couple the first end 127 (or the second end 129) of the fifth fluid conduit 125 to the second end 136 of the second fluid conduit 108 and a conduit connector 162 can be used to couple the second end 129 (or the first end 127) of the fifth fluid conduit 125 to the rotating part 124 of the second fluid swivel 120, respectively.

The conduit connectors 152, 154, 156, 158, 160, and 162 can independently be any type of connection device capable of forming a suitable connection. In some embodiments, the conduit connectors 152, 154, 156, 158, 160, and 162 can independently be configured as a hub and clamp connector, a flange connector, a compact flange connector, a collet connector, or any other suitable connector. In some embodiments, the hub and clamp connector can be a four bolt, a two bolt, or a single bolt hub and clamp connector.

In some embodiments, the first fluid conduit 106 can include one or more first valves 126. In some embodiments, the second fluid conduit 108 can include one or more second valves 128. In some embodiments, the third fluid conduit 110 can include one or more third valves 130. In some embodiments, the fourth fluid conduit 112 can include one or more fourth vales 132. In some embodiments, the first, second, third, and fourth valves 126, 128, 130, and 132 can independently be configured as through conduit valves. Suitable through conduit valves can be or can include, but are not limited to, a ball valve or a through conduit gate valve. In some embodiments, one or more of the first, second, third, and fourth valves 126, 128, 130, and 132 can be a double block and bleed type valve. Double block and bleed type valves are singles valve that include two seating surfaces that, in the closed position, provide a seal against pressure from both ends of the valve and includes the ability to bleed the cavity between the seating surfaces.

In some embodiments, when the fifth fluid conduit 125 maintains fluid communication between the fixed part 116 of the first fluid swivel 114 and the fourth fluid conduit 112, the first valve 126 and the fourth valve 132 can be in an open position and the second valve 128 and the third valve 130 can be in a closed position. In some embodiments, when the fifth fluid conduit 125 maintains fluid communication between the rotating part 124 of the second fluid swivel 120 and the second fluid conduit 108, the second valve 128 and the third valve 130 can be in an open position and the first valve 126 and the fourth valve 132 can be in a closed position.

In some embodiments, a process for redirecting a fluid flow from a first fluid path to a second fluid path of the system 100 configured to transfer a fluid between the first body 102 rotatively coupled to the second body 104 can include closing the first valve 126 and the fourth valve 132 of the system 100. The first fluid path can be defined by the first fluid conduit 106, the first valve 126, the first fluid swivel 114, the fifth fluid conduit 125, the fourth fluid conduit 112, the fourth valve 132, and a portion of the third fluid conduit 110. The fifth fluid conduit 125 can be disconnected from the fixed part 116 of the first fluid swivel 114 and the fourth fluid conduit 112. The fifth fluid conduit 125 can be connected to the second fluid conduit 108 and the rotating part 124 of the second fluid swivel 120. The second valve 128 and the third valve 130 can be opened to establish fluid communication between the second fluid conduit 108 and the third fluid conduit 110. The second fluid path can be defined by a portion of the first fluid conduit 106, the second fluid conduit 108, the second valve 128, the fifth fluid conduit 125, the second fluid swivel 120, the third valve 130, and the third fluid conduit 110.

FIG. 2 depicts a system 200, similar to the system 100 shown in FIG. 1, that includes a sixth fluid conduit 225, according to one or more embodiments. As shown in FIG. 2, the sixth fluid conduit 225 can be configured to maintain fluid communication between the second fluid conduit 108 and the rotating part 124 of the second fluid swivel 120. In some embodiments, the conduit connector 160 and the conduit connector 162 can be used to couple a first end 227 of the sixth fluid conduit 225 to the second end 136 of the second fluid conduit 108 and a second end 229 of the sixth fluid conduit 225 to the rotating part 124 of the second fluid swivel 120, respectively. In some embodiments, when the sixth fluid conduit 225 maintains fluid communication between the rotating part 124 of the second fluid swivel 120 and the second fluid conduit 108, the second valve 128 and the third valve 130 can be in an open position and the first valve 126 and the fourth valve 132 can be in a closed position. Line 105 represents the boundary between the first body 102 configured to rotate relative to the second body 104.

In some embodiments, the fifth fluid conduit 125 can be connected to the fixed part 116 of the first fluid swivel 114 and the fourth fluid conduit 112 and the sixth fluid conduit 225 can be connected to the second fluid conduit 108 and the rotating part 124 of the second fluid swivel 120 at the same time. However, if both the fifth fluid conduit 125 and the sixth fluid conduit 225 are connected at the same time, rotation of the first body 102 relative to the second body 104 should be limited or even prevented until one of the fifth fluid conduit 125 and the sixth fluid conduit 225 has been disconnected.

In some embodiments, a process for redirecting a fluid flow from a first fluid path to a second fluid path of the system 200 configured to transfer a fluid between the first body 102 rotatively coupled to the second body 104 can include closing the second valve 128 and the third valve 130 of the system 200. The first fluid path can be defined by a portion of the first fluid conduit 106, the second conduit 108, the second valve 128, the second fluid swivel 120, the sixth fluid conduit 225, the third valve 130, and the third fluid conduit 110. The sixth fluid conduit 225 can be disconnected from the second fluid conduit 108 and the rotating part 124 of the second fluid swivel 120. The sixth fluid conduit 225 or the fifth fluid conduit 125 can be connected to the fixed part 116 of the first fluid swivel 114 and the fourth fluid conduit 112. The first valve 126 and the fourth valve 132 can be opened to establish fluid communication between the first fluid conduit 106 and the fourth fluid conduit 112. The second fluid path can be defined by the first fluid conduit 106, the first valve 126, the first fluid swivel 114, the sixth fluid conduit 225 or the fifth fluid conduit 125, the fourth valve 132, the fourth fluid conduit 112, and a portion of the third fluid conduit 110.

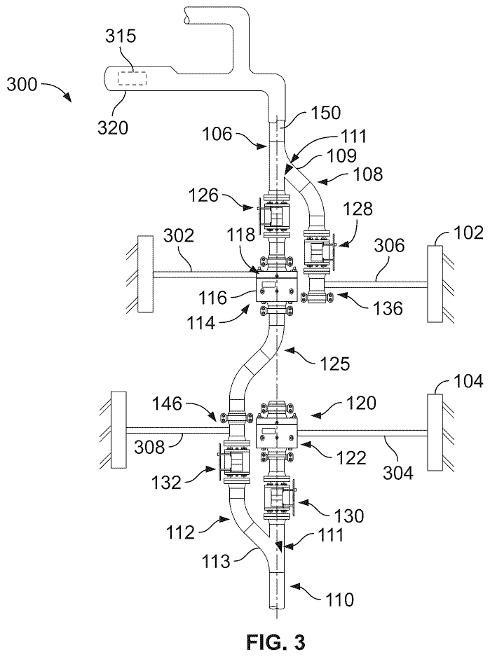

FIG. 3 depicts another illustrative system 300 for transferring a fluid between the first body 102 rotatively coupled to the second body 104 in a first configuration, according to one or more embodiments. In some embodiments, the rotating part 118 of the first fluid swivel 114 can be coupled to the first body 102 via a first torque arm 302. In some embodiments, the fixed part 122 of the second fluid swivel 120 can be coupled to the second body 104 via a second torque arm 304. In other embodiments, the rotating part 118 of the first fluid swivel 114 can be coupled to the first body 102 via the first torque arm 302 and the fixed part 122 of the second fluid swivel 120 can be coupled to the second body 104 via the second torque arm 304.

In some embodiments, the second fluid conduit 108 can be coupled to the first body 102 via a first conduit support 306. In some embodiments, fourth fluid conduit 112 can be coupled to the second body 104 via a second conduit support 308. In other embodiments, the second fluid conduit 108 can be coupled to the first body 102 via the first conduit support 306 and the fourth fluid conduit 112 can be coupled to the second body 104 via the second conduit support 308.

In some embodiments, when the fifth fluid conduit 125 maintains fluid communication between the fixed part 116 of the first fluid swivel 114 and the fourth fluid conduit 112, the system 300 can be configured to pass a pipeline inspection gauge or “pig” 315 through a fluid path defined by the first fluid conduit 106, the first valve 126, the first fluid swivel 114, the fifth fluid conduit 125, the fourth fluid conduit 112, the fourth valve 132, and a portion of the third fluid conduit 110. In other embodiments, when the fifth fluid conduit 125 maintains fluid communication between the rotating part 124 of the second fluid swivel 120 and the second fluid conduit 108 (see FIG. 2), the system 300 can be configured to pass the pig 315 through a fluid path defined by a portion of the first fluid conduit 106, the second fluid conduit 108, the second valve 128, the fifth fluid conduit 125, the second fluid swivel 120, the third valve 130, and the third fluid conduit 110.

In some embodiments the pig 315 can be spherically shaped or substantially spherically shaped. In some embodiments, the pig 315 can have a diameter that can be slightly less than an inner diameter of the first fluid swivel 114 and/or the second fluid swivel 120. For example, the pig 315 can have a diameter that can be equal to about 90%, about 93%, about 95%, about 97%, or about 99% of the inner diameter of the first fluid swivel 114 and/or the second fluid swive 120. In other embodiments, the pig 315 can have an oblong or elongated shape. For example, the pig 315 can have a length that can be greater than an inside diameter of the first fluid swivel 114 and/or an inside diameter of the second fluid swivel 120, such as an “intelligent” pig. In some embodiments, the pig 315 can have a length that can be about 1.1, about 1.5, about 2, about 3, about 4, about 5, or even about 6 times or more than the inside diameter of the first fluid swivel 114 and/or the second fluid swivel 120. In other embodiments, the pig 315 can be configured as an intelligent inspection pig or a scraper pig that can have an expandable, e.g., spring loaded, outer surface such that the outer diameter of the pig 314 can match an inner diameter of the first fluid swivel 114 and/or the second fluid swivel 120.

As shown in FIG. 3, in some embodiments, the connection between the first fluid conduit 106 and the second fluid conduit 108 and the connection between the third fluid conduit 110 and the fourth fluid conduit 112 can each be configured with a guide body or switch 111 that can be configured to direct the pig 315 therethrough. For example, when the pig 315 is to be introduced into the first fluid conduit 106, the guide body or switch 111 located at the connection between the first fluid conduit 106 and the second fluid conduit 108 can ensure the pig 315 travels through the first conduit 106 and through the first valve 126. In another example, when the pig 315 is to be returned through the third conduit 110 and into the fourth fluid conduit 112, the guide body or switch 111 located at the connection between the third fluid conduit 110 and the fourth fluid conduit 112 can ensure the pig 315 travels from the third conduit 110 and into the fourth conduit 112. In some embodiments, the guide body or switch 111 located at the connection between the first fluid conduit 106 and the second fluid conduit 108 and the guide body or switch 111 located at the connection between the third fluid conduit 110 and the fourth fluid conduit 112 can independently be configured as an internal gate or guide structure that can be positioned in a first position or a second position to direct the pig 315 therethrough via a desired path.

In some embodiments, an optional pig launcher/receiver 320 can be in fluid communication with the first fluid conduit 106. The pig launcher/receiver 320 can be configured to introduce the pig 315 into the first fluid conduit 106. The pig launcher/receiver 320 can also be configured to receive the pig 315 from the first fluid conduit 106. In some embodiments, the pig launcher/receiver 320 can be disposed on the first body 102. In some embodiments, the pig launcher/receiver 320 can be disposed on a floating vessel, e.g., a deck of the floating vessel, or any other structure to which the first body 102 may be attached or otherwise disposed on.

Certain embodiments and features have been described using a set of numerical upper limits and a set of numerical lower limits. It should be appreciated that ranges including the combination of any two values, e.g., the combination of any lower value with any upper value, the combination of any two lower values, and/or the combination of any two upper values are contemplated unless otherwise indicated. Certain lower limits, upper limits and ranges appear in one or more claims below. All numerical values are “about” or “approximately” the indicated value, and take into account experimental error and variations that would be expected by a person having ordinary skill in the art.

Various terms have been defined above. To the extent a term used in a claim can be not defined above, it should be given the broadest definition persons in the pertinent art have given that term as reflected in at least one printed publication or issued patent. Furthermore, all patents, test procedures, and other documents cited in this application are fully incorporated by reference to the extent such disclosure can be not inconsistent with this application and for all jurisdictions in which such incorporation can be permitted.

While certain preferred embodiments of the present invention have been illustrated and described in detail above, it can be apparent that modifications and adaptations thereof will occur to those having ordinary skill in the art. It should be, therefore, expressly understood that such modifications and adaptations may be devised without departing from the basic scope thereof, and the scope thereof can be determined by the claims that follow.

What is claimed is:

1. A system for transferring a fluid between a first body rotatively coupled to a second body, comprising:
a first fluid conduit configured to be disposed on the first body;
a second fluid conduit in fluid communication with the first fluid conduit;
a third fluid conduit configured to be disposed on the second body;
a fourth fluid conduit in fluid communication with the third fluid conduit;
a first fluid swivel comprising a fixed part rotatively coupled to a rotating part, wherein the rotating part of the first fluid swivel is in fluid communication with the first fluid conduit;
a second fluid swivel comprising a fixed part rotatively coupled to a rotating part, wherein the fixed part of the second fluid swivel is in fluid communication with the third fluid conduit; and
a fifth fluid conduit configured to maintain fluid communication between (i) the fixed part of the first fluid swivel and the fourth fluid conduit or (ii) the second fluid conduit and the rotating part of the second fluid swivel.

2. The system of claim 1, wherein:
the first fluid conduit comprises a first valve,
the second fluid conduit comprises a second valve,
the third fluid conduit comprises a third valve, and
the fourth fluid conduit comprises a fourth valve.

3. The system of claim 2, wherein at least one of the first valve, the second valve, the third valve, and the fourth valve is a double block and bleed type valve.

4. The system of claim 2, wherein:
when the fifth fluid conduit maintains fluid communication between the fixed part of the first fluid swivel and the fourth fluid conduit, the first valve and the fourth valve are in an open position and the second valve and the third valve are in a closed position, and
when the fifth fluid conduit maintains fluid communication between the rotating part of the second fluid swivel and the second fluid conduit, the second valve and the third valve are in an open position and the first valve and the fourth valve are in a closed position.

5. The system of claim 2, wherein, when the fifth fluid conduit maintains fluid communication between the fixed part of the first fluid swivel and the fourth fluid conduit, the system is configured to pass a pig through a fluid path defined by the first fluid conduit, the first valve, the first fluid swivel, the fourth fluid conduit, the fourth valve, and a portion of the third fluid conduit.

6. The system of claim 2, wherein, when the fifth fluid conduit maintains fluid communication between the rotating part of the second fluid swivel and the second fluid conduit, the system is configured to pass a pig through a fluid path defined by a portion of the first fluid conduit, the second fluid conduit, the second valve, the second fluid swivel, the third valve, and the third fluid conduit.

7. The system of claim 2, wherein:
a first end of the second fluid conduit is in fluid communication with the first fluid conduit at a location between a first end and a second end of the first fluid conduit,
a first end of the third fluid conduit is in fluid communication with the fixed part of the second fluid swivel, and
a second end of the fourth fluid conduit is in fluid communication with the third fluid conduit at a location between the first end and a second end of the third fluid conduit.

8. The system of claim 7, wherein:
the first valve is disposed between the location the first end of the second fluid conduit is in fluid communication with the first fluid conduit and the rotating part of the first fluid swivel,
the second valve is disposed between the first end and the second end of the second fluid conduit,
the third valve is disposed between the fixed part of the second fluid swivel and the second end of the third fluid conduit, and
the fourth valve is disposed between the location the second end of the fourth fluid conduit is in fluid communication with the third fluid conduit and the first end of the fourth fluid conduit.

9. The system of claim 1, wherein the fifth fluid conduit is configured to maintain fluid communication between the fixed part of the first fluid swivel and a first end of the fourth fluid conduit.

10. The system of claim 1, wherein the fifth fluid conduit is configured to maintain fluid communication between a second end of the second fluid conduit and the rotating part of the second fluid swivel.

11. The system of claim 1, wherein:
the first body rotates relative to the second body about a longitudinal axis,
at least a portion of the first fluid conduit is longitudinally aligned with the longitudinal axis, and
at least a portion of the third fluid conduit is longitudinally aligned with the longitudinal axis.

12. The system of claim 1, wherein:
the first body rotates relative to the second body about a longitudinal axis,
the first fluid swivel and the second fluid swivel each define a bore therethrough, and
the bore defined by the first fluid swivel and the bore defined by the second fluid swivel are aligned along the longitudinal axis.

13. The system of claim 12, wherein:
at least a portion of the first fluid conduit is longitudinally aligned with the longitudinal axis, and
at least a portion of the third fluid conduit is longitudinally aligned with the longitudinal axis.

14. The system of claim 1, wherein:
the rotating part of the first fluid swivel is coupled to the first body via a first torque arm,
the fixed part of the second fluid swivel is coupled to the second body via a second torque arm, or
the rotating part of the first fluid swivel is coupled to the first body via a first torque arm and the fixed part of the second fluid swivel is coupled to the second body via a second torque arm.

15. The system of claim 1, wherein:
the second fluid conduit is coupled to the first body via a first conduit support,
the fourth fluid conduit is coupled to the second body via a second conduit support, or
the second fluid conduit is coupled to the first body via a first conduit support and the fourth fluid conduit is coupled to the second body via a second conduit support.

16. The system of claim 1, wherein:
the first fluid conduit and the second fluid conduit are connected to one another in a wye configuration, and
the third fluid conduit and the fourth fluid conduit are connected to one another in a wye configuration.

17. The system of claim 1, wherein the fifth fluid conduit is configured to maintain fluid communication between the fixed part of the first fluid swivel and the fourth fluid conduit, and the system further comprises a sixth fluid conduit configured to maintain fluid communication between the second fluid conduit and the rotating part of the second fluid swivel.

18. The system of claim 17, wherein;
when the fifth fluid conduit maintains fluid communication between the fixed part of the first fluid swivel and the fourth fluid conduit, the sixth fluid conduit is disconnected from the rotating part of the second fluid swivel and the second fluid conduit, and
when the sixth fluid conduit maintains fluid communication with the rotating part of the second fluid swivel and the second fluid conduit, the fifth fluid conduit is disconnected from the fixed part of the first fluid swivel and the fourth fluid conduit.

19. A system for transferring a fluid between a first body rotatively coupled to a second body, comprising:
a first fluid conduit disposed on the first body and comprising a first valve;
a second fluid conduit in fluid communication with the first fluid conduit and comprising a second valve;
a third fluid conduit disposed on the second body and comprising a third valve;
a fourth fluid conduit in fluid communication with the third fluid conduit and comprising a fourth valve;
a first fluid swivel comprising a fixed part rotatively coupled to a rotating part, wherein the rotating part of the first fluid swivel is in fluid communication with the first fluid conduit;
a second fluid swivel comprising a fixed part rotatively coupled to a rotating part, wherein the fixed part of the second fluid swivel is in fluid communication with third fluid conduit; and
a fifth fluid conduit configured to fluidly connect to either one of: (i) the fixed part of the first fluid swivel and the fourth fluid conduit or (ii) the rotating part of the second fluid swivel and the second fluid conduit, wherein:
the first fluid conduit, the first valve, the first fluid swivel, the fifth fluid conduit, and the fourth fluid conduit define a first fluid path when the fifth fluid conduit is fluidly connected to the fixed part of the first fluid swivel and the fourth fluid conduit, and
the second fluid conduit, the second valve, the fifth fluid conduit, the second fluid swivel, and the third fluid conduit define a second fluid path when the fifth fluid conduit is fluidly connected to the rotating part of the second fluid swivel and the second fluid conduit.

20. A process for redirecting a fluid flow from a first fluid path to a second fluid path in a system configured to transfer a fluid between a first body rotatively coupled to a second body, comprising:
closing a first valve and a fourth valve of the system, wherein the system comprises:
a first fluid conduit disposed on the first body and comprising the first valve,
a second fluid conduit in fluid communication with the first fluid conduit and comprising a second valve,
a third fluid conduit disposed on the second body and comprising a third valve,
a fourth fluid conduit in fluid communication with the third fluid conduit and comprising the fourth valve,
a first fluid swivel comprising a fixed part rotatively coupled to a rotating part, wherein the rotating part of the first fluid swivel is in fluid communication with the first fluid conduit,
a second fluid swivel comprising a fixed part rotatively coupled to a rotating part, wherein the fixed part of the second fluid swivel is in fluid communication with third fluid conduit; and
a fifth fluid conduit fluidly connected to the fixed part of the first fluid swivel and the fourth fluid conduit, wherein the first fluid path is defined by the first fluid conduit, the first valve, the first fluid swivel, the fifth fluid conduit, the fourth fluid conduit, and the fourth valve;
disconnecting the fifth fluid conduit from the fixed part of the first fluid swivel and the fourth fluid conduit;
connecting the fifth fluid conduit or a sixth fluid conduit to the second fluid conduit and the rotating part of the second fluid swivel; and
opening the second valve and the third valve to establish fluid communication between the second fluid conduit and the third fluid conduit, wherein the second fluid path is defined by the second fluid conduit, the second valve, the fifth fluid conduit or the sixth fluid conduit, the second fluid swivel, the third valve, and the third fluid conduit.
